(19) United States
(12) Patent Application Publication
(10) Pub. No.: US 2004/0240600 A1
(43) Pub. Date: Dec. 2, 2004

(54) Positron annihilation for inspection of land based industrial gas turbine components

(75) Inventors: Paula Denise Freyer, Fombell, PA (US); Paul John Zombo, Cocoa, FL (US)

Correspondence Address: Siemens Corporation, Intellectual Property Department, 170 Wood Avenue South, Iselin, NJ, 08830, US

(73) Assignee: Siemens Westinghouse Power Corporation

(21) Appl. No.: 10/854,875

(22) Filed: May 27, 2004

Related U.S. Application Data
(60) Provisional application No. 60/474,385, filed on May 30, 2003.

(51) Int. Cl. F02C 3/14

(52) U.S. Cl. 376/159

(57) ABSTRACT

The present invention relates to the use of positron annihilation spectroscopy (PAS) as a method for the measurement of material damage in hot gas path components in industrial gas turbines. A method measuring material damage, expended life and remaining life, using PAS, in nickel and cobalt based superalloy turbine components where the damage has been created by engine operational exposure, is provided. The method can also be used to assess damage to metal components in steam turbines, heat exchangers and generators, as well as damage to other metal, ceramic, plastic and composite articles.

### CROSS-REFERENCE TO RELATED APPLICATIONS

This application claims priority under 35 USC §119(e) to provisional application 60/474,385, filed May 30, 2003.

### FIELD OF THE INVENTION

The present invention relates to the use of positron annihilation spectroscopy (PAS) as a method for the measurement of material damage. The method can be used to assess damage to metal components in gas and steam turbines, heat exchangers and generators, as well as damage to other metal, ceramic, plastic and composite articles.

### BACKGROUND INFORMATION

As gas turbine components operate under harsh engine environments, changes in the material microstructure occur with time, temperature and stress state. Because of the complex temperature and stress conditions imposed on hot gas path components, these microstructural changes are exceedingly complex but are typically cumulative, i.e., the overall microstructural damage of the material accumulates with increasing service exposure. Under normal engine operating conditions, microstructural damage continues to accumulate in the component, until the critical level of damage is finally obtained, at which time, failure (i.e., cracking) of the metallic component may occur. In contrast to this slowly accumulating material damage under normal operating conditions, excursions in engine operation may also occur (i.e., temperature and/or stress spikes), in which case, significant levels of material damage within engine components may occur essentially instantaneously.

Gas turbine components are designed through the use of sophisticated computer simulations using alloy properties representative of a newly manufactured component in addition to engineering estimates of the temperature and stress conditions expected in the engine operational environment. An important output of these computer models is an estimate of the ‘life’ of the component, i.e., the amount of accumulated microstructural damage the component is capable of withstanding without suffering a failure. Using an approximation of the damage accumulation rate of various engine components based, again, on estimated engine service conditions along with historical operational experience, the ‘life’ of the component can be estimated in terms of number of hours of operation. This component design life, reported as an acceptable number of hours the component can be safely operated in an engine, determines not only when a component must be removed from service, but also determines the inspection and repair intervals for parts. Note that the number of operational hours is generally assigned to a component only after a ‘safety factor’ is applied, further reducing the ‘design life’ for a particular component.

Using the calculated design life of a component, which has been reduced through the use of safety factors, and by estimating the damage accumulation rate during engine service, it is possible to determine the amount of ‘consumed life’, and hence, the ‘remaining life’ for a particular component. Unfortunately, because of intrinsic errors in design calculations and estimated engine operating conditions (i.e., estimated damage accumulation rates), this mathematical approach to determining consumed life and subsequently, remaining life, can be extremely inaccurate. Additional complexities arise from the fact that each gas turbine has unique operating environments that can fluctuate significantly, even during normal operation. Furthermore, each set of components in the turbine, for example, blades operating in row 1 versus row 2, can experience dramatically different exposure conditions and in fact, conditions can differ significantly for components within the same sets or even for various locations on the same component. There remains a need for methods of accurately assessing damage to turbine components and the consumed life/remaining life of the components.

An accurate assessment of component consumed life and/or remaining life is critical for efficient operation and maintenance of expensive hot gas path components and as such, has been a major focus area for development in the gas turbine industry. As previously mentioned, accurate part life assessment allows for the determination of more accurate part inspection, repair and replacement intervals which, considering the high cost of complex turbine components, could contribute to significant cost savings. In addition, accurate parts' life assessment enables engine owners to optimize the operating conditions of their units to obtain the maximum number of service hours from their individual components. Further, under abnormal engine operating conditions (i.e., stress and/or temperature excursions), accurate parts damage assessment is crucial for the determination of the rapid damage created in the components under the excursion conditions; no methodology currently exists for determining the impact of such off-design operation on the integrity of components. In addition, the current approach used by industry is typically to retire parts from service once they have met their original design life. This approach, which assumes the damage accumulation rate for components is the same for different engines, does not allow for the significant fluctuations in operating conditions known to exist from engine to engine. Therefore, accurate assessment of part life may allow for the extension of component life past the original calculated design life and could further allow for the critical re-analysis of design calculations and methodologies.

By performing non-destructive (NDE) measurements directly on parts to measure material damage (as opposed to relying on modeled predictions), it is possible to obtain a far more accurate assessment of gas turbine component remaining life. Numerous NDE techniques have been investigated, including fluorescent penetration, ultrasonics, eddy current, and visual inspection, all of which can only detect material damage in the form of a crack, i.e., the part life has already been essentially consumed. These techniques generally allow for relatively shallow interrogation of the material surface (therefore, the life-limiting feature must be at or near the part surface) and typically compete to determine which technique can detect the smallest crack size. Therefore, at best, these NDE techniques are really only pass-fail inspections and do not supply any information regarding the pre-crack damage condition of the material.

Various nuclear spectroscopy experimental techniques were heavily developed in the two decades after 1945 with experiments using positrons dedicated to the study of electronic structure, such as the Fermi surface in metals and alloys. Today, a number of positron spectroscopy approaches exist which measure specific characteristics of the inherent gamma rays associated with positron and electron annihilation and include, but are not limited to angular correlation of annihilation, doppler broadening and doppler shift of the annihilation line and positron lifetime. It has been known since the 1960's that positrons are sensitive to lattice imperfections and can become trapped in crystal defects until annihilation, causing a change in the positron annihilation response. This trapping behavior was used to evaluate material behavior and included the study of thermal vacancies in metals, ionic crystals and the plastic deformation of semiconductors.

Recently, positron annihilation spectroscopy (PAS) has been used to determine the extent of embrittlement, fatigue or dislocations throughout a metal specimen, as described in Akers et al., U.S. Pat. No. 6,178,218. Akers describes a method of using PAS to determine the extent of specific types of damage by comparison of the damaged part with known metal samples. There is no disclosure of a method of analyzing gamma ray data to determine the expended life or remaining life of the metal part.

### SUMMARY OF THE INVENTION

Accordingly, the present invention provides a method of determining the damage state, expended life and remaining life of a superalloy industrial gas turbine component using positron annihilation spectroscopy. The method comprises providing a source of positrons which can interact with the atomic structure of the turbine component to effect emission of gamma radiation; acquiring gamma radiation data indicative of the size, type and quantity of defects (as hereinafter defined) present in the component; and analyzing the data to determine the damage state, expended life and remaining life of said component.

In one embodiment, the positrons are produced internally in the component by injection of high energy particles into the component. In another embodiment, the positrons are provided from a source external to the component.

Positron annihilation spectroscopy (PAS), a nuclear spectroscopy method, is a technique especially suited for the measurement of the pre-crack damage condition and hence, the expended and remaining life of gas turbine materials. Positrons, anti-particles of electrons, are extremely sensitive to changes in a material's atomic structure. By measuring specific characteristics of the positrons as they interact with the bulk material, PAS serves as an advanced and valuable NDE tool. The technique offers the unique advantage of detecting damage in materials prior to crack initiation. Additional benefits, especially applicable to gas turbine components, are that the method is geometry and material surface condition independent and has the capability of being used in-situ. The method can also be used to evaluate components of steam turbines, heat exchangers, or generators, as well other types of metal, ceramic, plastic or composite articles.

PAS works on the basis that a positively charged positron will be attracted to lower positive charge density regions in a lattice structure, such as defects in a bulk metal. These defect areas contain a higher ratio of low momentum valence electrons than do non-defect areas. The positrons become ‘trapped’ in these defect areas until they annihilate with local electrons with the simultaneous emission of two 511 keV gamma rays. Detection and measurement of various characteristics of the emitted gamma rays provides detailed information regarding the size, type and quantity of defects present in the material under interrogation. Atomic structure variations, therefore, provide different annihilation ‘signatures’ and supply detailed information regarding the microstructural condition of a material. In this way, PAS can be used to determine the damage state, the expended life, and the remaining life of a material. Because gas turbine operational exposure creates microstructural ‘defects’ in the turbine components which accumulate over time, the positron signal can be correlated with component accumulated damage, part engine exposure history, consumed life and finally, remaining life.

It is an object of the present invention, therefore, to provide a method of determining the damage state, expended life and remaining life of a material, using positron annihilation spectrometry.

It is an additional object of the present invention to provide a method of determining the damage state, expended life and remaining life of gas turbine components, steam turbine components, heat exchangers or generators, as well as of other metal, ceramic, plastic and/or composite materials, using positron annihilation spectrometry.

These and other objects will become more readily apparent from the following drawings, detailed description and appended claims.

### BRIEF DESCRIPTION OF THE DRAWINGS

The invention is further illustrated by the following drawings in which:

FIG. 1 is a computer generated illustration of stepped creep specimens following creep failure. Locations 1 through 5 represent the PAS measurement locations. Samples are nickel base superalloy IN738 with an equiaxed grain structure.

FIG. 2 is a graph illustrating positron annihilation spectroscopy results for crept equiaxed nickel base superalloy IN738 (specimen shown in FIG. 1).

FIGS. 3A and 3B are computer generated illustrations showing the locations of measurements taken on gas turbine exposed blades manufactured from single crystal superalloy PWA1483.

FIG. 4 is a graph illustrating positron annihilation spectroscopy results for the measurements taken on the blades shown in FIG. 3A-3B.

FIG. 5 is a graph illustrating positron annihilation spectroscopy results for various gas turbine exposed blades manufactured from single crystal superalloy PWA1483.

### DETAILED DESCRIPTION OF PREFERRED EMBODIMENTS

The present invention provides a method of determining the damage state, expended life and remaining life of a superalloy industrial gas turbine component using positron annihilation spectroscopy. The method comprises providing a source of positrons which can interact with the atomic structure of the turbine component to effect emission of gamma radiation; acquiring gamma radiation data indicative of the size, type and quantity of defects present in the component; and analyzing the data to determine the damage state, expended life and/or remaining life of said component.

In one embodiment, the positrons are produced internally in the component by injection of high energy particles into the component. Such injection can be accomplished, for example, by using a neutron beam. Neutrons from the neutron source are directed at the metal article, and the resulting gamma radiation, emitted during the annihilation event, is detected and measured. Such methods are well known in the art.

When positrons are produced internally to the component, the interrogation depth ranges from about less than one inch up to about four inches.

In another embodiment, the positrons are provided from a source external to the component. Suitable sources of positrons include sodium-22, for example. External sources of positrons are also well known in the art, and other sources are contemplated as suitable for the methods of the present invention. Typically, the external source material is placed in close proximity to the material under evaluation, and in some circumstances, in direct contact with the material under investigation. In this instance, the positrons are produced externally to the material under investigation and manage only shallow penetration of the material, on the order of about a millimeter, depending on the density of the material under investigation. In this method, volumetric, bulk evaluation of the material is not possible.

Gamma radiation detectors are known in the art. A suitable gamma radiation detector is described in Akers, U.S. Pat. 6,178,218. The gamma rays are detected, and data indicative of the size, type and quantity of defects present in the component is acquired. In one embodiment, at least one detector is used. In another embodiment, a plurality of detectors are used. The data is then analyzed to determine the damage state, expended life and remaining life of the component. Measurements taken on the material of interest are compared to measurements taken on parts which are new, and/or compared to measurements taken on parts having known amounts of damage, either from damage produced in a laboratory setting or damage produced during engine operation. Based on a knowledge of metallurgy, component design, and operating history, the total, cumulative damage and remaining life can be determined.

In one embodiment, the material under evaluation is a superalloy gas turbine component. The turbine component can be newly manufactured, or can be one that has been previously exposed to industrial gas turbine service. The superalloy turbine component can be one which has been joined by welding, brazing, bonding, or other method of part manufacture. The turbine component can also be one previously rejuvenated by thermal heat treatments.

The superalloy turbine component can be any type of superalloy, including, but not limited to, nickel-based superalloys, including those having a cast equiaxed multigrained structure, a cast directionally solidified grain structure, a cast single crystal grain structure, a rolled sheet structure, and a forged grain structure. The superalloy can also be a cobalt-based alloy, including cobalt-based alloys having a cast equiaxed multigrained structure. The superalloy may have a coating, including, by way of example only, a protective metal coating, ceramic coating, or a combination of these.

In an additional embodiment, the present invention provides a method of determining the damage state, expended life and remaining life of a component of a steam turbine, heat exchanger, or generator using positron annihilation spectroscopy, comprising: providing a source of positrons which can interact with the atomic structure of the component; acquiring gamma radiation data indicative of the size, type and quantity of defects present in the component; and analyzing the data to determine the damage state, expended life and remaining life of the component.

In an additional embodiment, the present invention provides a method of determining the damage state, expended life and remaining life of a metal, ceramic, plastic or composite article, using positron annihilation spectroscopy, comprising: providing a source of positrons which can interact with the atomic structure of the article; acquiring gamma radiation data indicative of the size, type and quantity of defects present in the article; and analyzing the data to determine the damage state, expended life and remaining life of the article. The damage in a component of a steam turbine, heat exchanger, or generator, or damage in other metal, ceramic or composite articles, can be determined by comparing the damaged component or article to a new component or article, or one having a known amount of damage, to determine the damage state, expended life and/or remaining life of the component or article.

The damage mechanisms in hot gas path components exposed to gas turbine operation include thermo-mechanical fatigue (TMF) in metals and coatings, creep in metals and coatings, disbonding and microcracking in metals, coatings and at interfaces. Potential damage in turbine components includes, but is not limited to, fatigue damage, creep damage, thermal degradation of material microstructure, development and propagation of microcracks, disbonds, internal void formation and link-up of porosity, coating and base metal interactions, and changes in grain size and grain boundary morphology, hereinbefore referred to as “defects”. The damage occurs as an incremental accumulation process and can occur in several stages. For example, under engine operational conditions, pores or voids in a metal structure can link to form a brittle microcrack which then propagates during service, eventually reaching a potentially catastrophic size under further temperature and stress exposure. A complicating factor is that under turbine engine operating conditions, a number of different damage mechanisms occur simultaneously within the exposed material; the accumulation of and the interaction between these defects is exceedingly complex. This type of cumulative and interactive damage is a particular concern for hot gas path components which are manufactured using a variety of materials including nickel base superalloys (cast as either equiaxed, directionally solidified or single crystal structures), equiaxed cobalt base superalloys and nickel base forgings and sheet materials. These components may be manufactured and placed into service without the use of protective coatings or they may include a variety of ceramic thermal barrier coatings (TBC) and/or metallic coatings. Note that a particular advantage of positron annihilation is it's ability to examine metallic components through and under these types of coating systems.

PAS allows one to acquire three dimensional data on materials. For example, the data can be mapped not only to particular regions on a blade, but also to a particular location within a turbine. This can be done by acquiring damage data over time on in-service components, and noting location information in combination with the damage information, such that the location of the damage on a particular part, and the part's location within the turbine is recorded. For example, the gamma radiation is emitted from a specific location and depth in the component or other article being tested, the location and depth having specific coordinates. The coordinates of the gamma radiation emission are recorded at the time of data acquisition. One skilled in the art can easily determine the requisite level of detail for noting location and depth when recording the coordinates.

Thus, in an additional aspect, the method of the present invention further comprises recording the coordinates of gamma radiation emitted from the component or article, and combining the coordinates with information on the damage state, to produce a map of the damage on the component or article and/or a map of the damage within the gas or steam turbine, heat exchanger, or generator, or other machine where the articles under investigation may be used. As used herein, “coordinates” refers to all types of location information, including, but not limited to, depth information, two- or three-dimensional position information on a particular component and the location of the component within the turbine or other engine or machine.

Over time, data can be accumulated which allows mapping of particular types of damage to particular locations within the turbine (or other machine such as steam turbine, heat exchanger or generator and the like). This ability to map measurements adds a new and necessary dimension to the damage assessment and remaining life determination. For example, areas having TMF will give a TMF dominated measurement and areas that are creep limited may give a creep dominated measurement. If a specific blade gives a typical TMF degradation measurement but a creep measurement that is indicative of low degradation, the combined effects should be looked at to determine what the remaining life should be for continued peak service, as well as for continued base service. Also using one or more regions on the component as a base-line could help simplify the information for remaining life determination. For example, new parts can be used as a base line, or the root of the blade can be used as a baseline.

Degradation modes and their severity can also be differentiated by depth mapping of the measurements. This can be done by restricting measurements to a variety of penetrating depths and comparing the data to historical archives or analytical damage models. For example, high cycle fatigue (HCF) degradation is surface concentrated in regions of high bending loads, with the internal metal hardly degraded. Creep damage does not have as strong a surface dominance. Therefore, an evaluation of damage state and remaining life can include evaluation of both the internal measurement and the surface measurement, thus providing an improved differentiation of degradation mode and remaining life. The use of an array of detectors also aids in the mapping of the information. Spatial patterns of damage obtained from mapping can be further analyzed to provide an indication of the damage state, expended life and remaining life of the component or article.

### EXAMPLES

The following examples are intended to illustrate the invention and should not be construed as limiting the invention in any way.

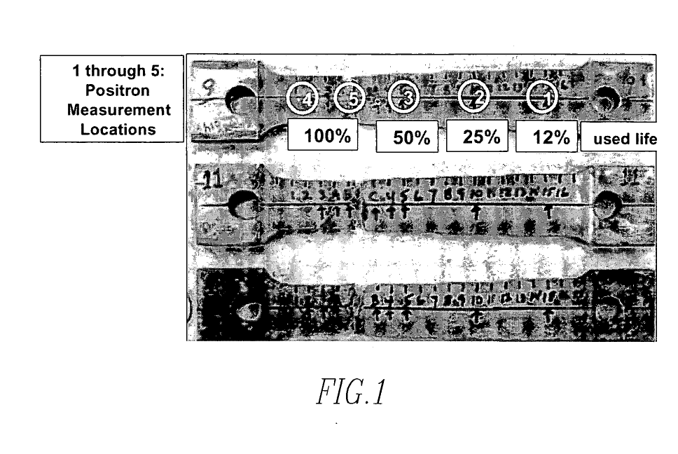

Cast IN738 equiaxed specimens with various levels of creep and thermally induced damage were interrogated using PAS. Specimens with unique stepped gage section geometries were creep tested under various test conditions as shown in Table 1. Specimens were tested at two (2) test temperatures and three (3) different stress conditions. Because of the variation in gage section thickness, the amount of consumed creep life in each section decreases with increasing gage thickness. Following creep failure in the thinnest gauge section, specimens were PAS interrogated at five (5) locations, each location representing a different level of expended and remaining life dependant on the gage thickness at each location (FIG. 1).

TABLE 1
Stepped creep specimen test conditions and corresponding test results

| | | | | Hours at | | |
|---|---|---|---|---|---|---|
| | | Test | Exposure | Temperature | Stress in | Stress in |
| Sample | | Temperature | Temperature | (i.e., Rupture | Thinnest Gauge | Thinnest Gauge |
| ID | Alloy | (F.) | (C.) | Life) | Section (ksi) | Section (MPa) |
| 9 | IN738CC | 1500 | 816 | 89 | 63 | 434 |
| 11 | IN738CC | 1500 | 816 | 303 | 52 | 360 |
| 13 | IN738CC | 1750 | 954 | 57 | 26 | 178 |

TABLE 2
Thermally exposed specimen conditions

| | | | | | | | | | Creep Stress | Creep Stress |
|---|---|---|---|---|---|---|---|---|---|---|
| Sample | | | | | | Max | Max | Hours at | in Thinnest | in Thinnest |
| Set | Sample | | Grain | Sample | | Temp | Temp | Max | Gage | Gage Section |
| Number | ID | Alloy | Structure | Form | Test Type | (F.) | (C.) | Temp | Section (ksi) | (MPa) |
| | 9a | IN738CC | Equiaxed | Machined | Thermally | 1500 | 816 | 100 | 0 | 0 |
| | | | | Blank | Exposed | | | | | |
| 2 | 15 | IN738CC | Equiaxed | Machined | Thermally | 1500 | 816 | 6400 | 0 | 0 |
| | | | | Blank | Exposed | | | | | |
| | 23 | IN738CC | Equiaxed | Machined | Thermally | 1750 | 954 | 100 | 0 | 0 |
| | | | | Blank | Exposed | | | | | |
| | 29 | IN738CC | Equiaxed | Machined | Thermally | 1750 | 954 | 6400 | 0 | 0 |
| | | | | Blank | Exposed | | | | | |

The specimens summarized in Table 2 were prepared from a typical high temperature conventionally cast equiaxed alloy, IN738CC. The samples were thermally exposed for various times (i.e., 100 and 6400 hours) at elevated temperatures (i.e., 1500° and 1750° F.) in air environments to simulate both short and long term thermal conditions that hot section gas turbine components such as blades and vanes are exposed to during engine operation. The samples were not subjected to any form of mechanical loading, but instead were only thermally exposed. Such long term exposure of these types of alloys to elevated temperatures is known to degrade the microstructure of the material, an effect referred to as “thermal aging”.

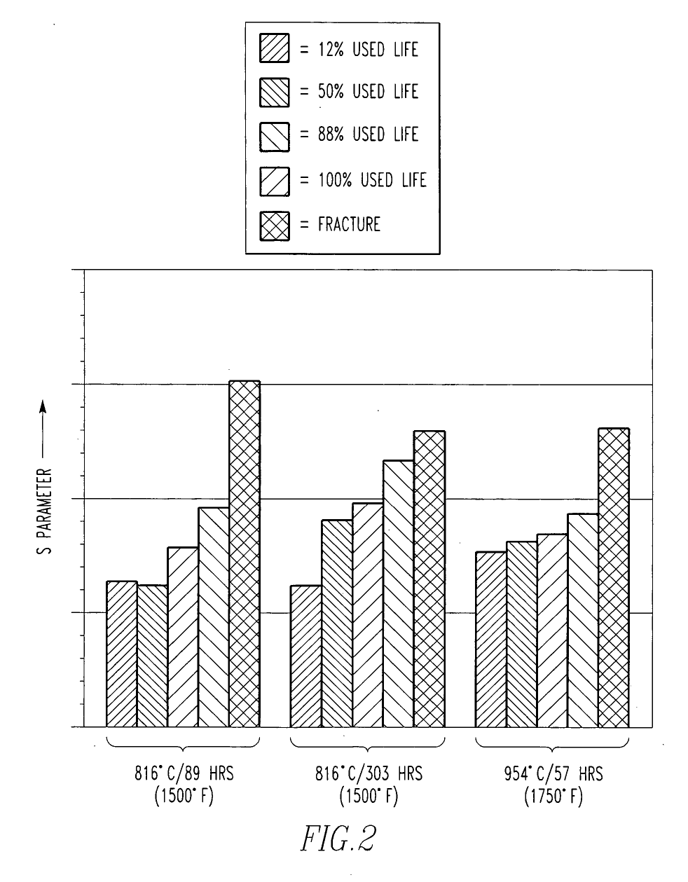

The PAS measurement results at the five (5) locations measured on each specimen are shown in FIG. 2. Clearly, the positron signal, shown here in terms of a line shape parameter S, shows a consistent trend with the damage condition within the various thickness gage sections and therefore, reliably measures the level of consumed life in each gage section. In addition, the positron signal distinguishes the effects caused by time at temperature (89 versus 303 hours at 819° C.) and the effect of temperature (819° C. versus 954° C.). This set of samples plainly illustrates the use of PAS as an NDE tool for the evaluation of both creep and thermally induced damage in the nickel superalloy IN738 .

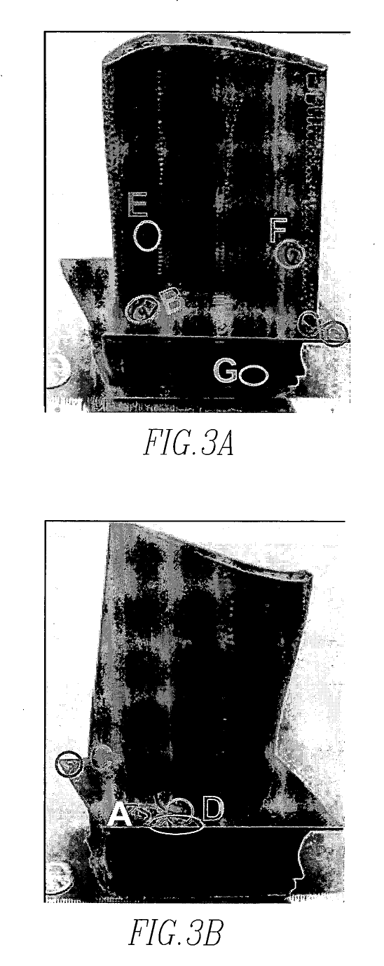

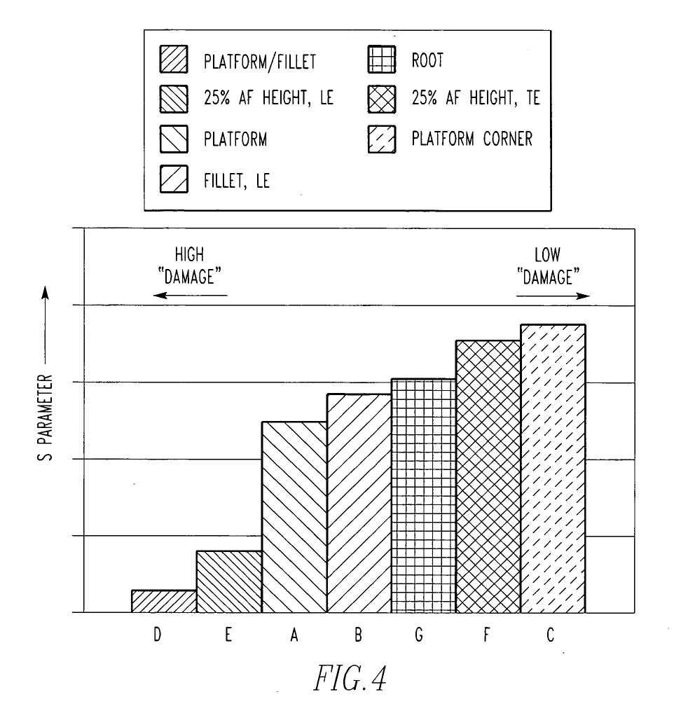

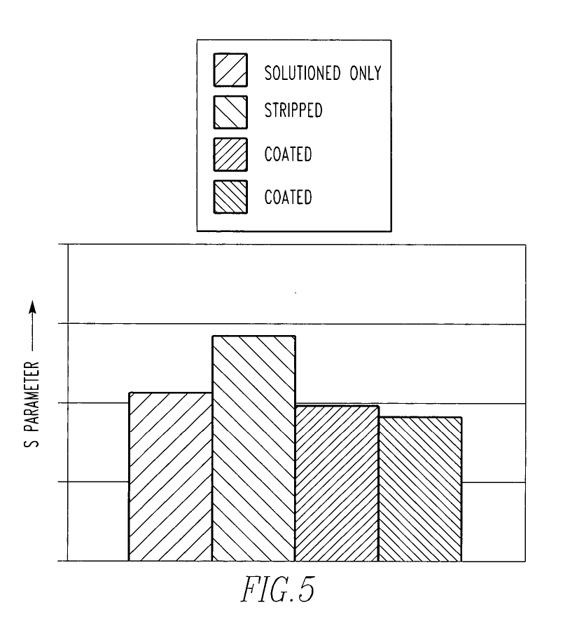

Positrons were also used to interrogate engine exposed hot gas path single crystal PWA1483 blades as shown in FIGS. 3A and 3B. FIG. 4 shows the ability of PAS to measure the damage accumulation at various locations within the same part while FIG. 5 shows the use of PAS to evaluate the same location on blades obtained from different engines which therefore have different levels of total accumulated damage. The positron measurement results shown in FIG. 4 match closely with finite element model results for the same part which predict stress levels for various locations on the component. Such localized measurements allow for the use of known high, intermediate and low damaged areas on the same component as reference locations, each location representing either high, intermediate or low levels of consumed life. The positron results shown in FIG. 5 shows that PAS can distinguish between newly manufactured components and those which have been exposed to different engine operating conditions.

The empirical trends on both the blade and stepped specimens noted in FIGS. 2 and 4 are very strong. However, it can be seen that each demonstrates the opposite trend. Although not wishing to be bound by any theories, it is thought that this may be because the service exposed component has experienced mixed/simultaneous degradation modes, such as compressive and tensile stresses applied in opposite directions, cyclic and/or steady state stresses, and the like. In contrast, the laboratory specimens were tensile loaded only, in one direction. Different regions of the component are degraded differently relative to the other regions and also relative to the operational mode of the engine. Based on initial studies, it appears that thermal exposure alone first causes an initial decrease in the S signal, followed by a gradual increase in the signal with continued thermal exposure. If mechanical damage is also present, it appears that the signal consistently increases with increasing mechanical damage.

Whereas particular embodiments of this invention have been described above for purposes of illustration, it will be evident to those skilled in the art that numerous variations of the details of the present invention may be made without departing from the invention as defined in the appended claims.

We claim:

1. A method of determining the damage state, expended life and/or remaining life of a superalloy industrial gas turbine component using positron annihilation spectroscopy comprising:
providing a source of positrons which can interact with the atomic structure of said component to effect emission of gamma radiation;
acquiring gamma radiation data indicative of the size, type or quantity of defects present in said component; and
analyzing said data to determine the damage state, expended life or remaining life of said component.

2. The method of claim 1, wherein said positrons are provided internally in said component by injection of high energy particles into said component.

3. The method of claim 1, wherein said positrons are provided from a source external to said component.

4. The method of claim 1 where the superalloy component has been exposed to industrial gas turbine service.

5. The method of claim 1 where the superalloy component is newly manufactured.

6. The method of claim 1 where the superalloy component has been joined by welding, brazing or bonding.

7. The method of claim 1 where the superalloy component has been rejuvenated through thermal heat treatments.

8. The method of claim 1 where the superalloy component is a nickel based superalloy consisting of a cast equiaxed multi-grained structure.

9. The method of claim 1 where the superalloy component is a nickel based superalloy consisting of cast directionally solidified grain structure.

10. The method of claim 1 where the superalloy component is a nickel base superalloy consisting of cast single crystal grain structure.

11. The method of claim 1 where the superalloy component is a nickel base superalloy consisting of forged grain structure.

12. The method of claim 1 where the superalloy component is a nickel base superalloy consisting of rolled sheet structure.

13. The method of claim 1 where the superalloy component is a cobalt base superalloy consisting of a cast equiaxed multi-grained structure.

14. The method of claims 4, 5, 6 or 7, where the superalloy component has a protective metallic coating.

15. The method of claims 4, 5, 6 or 7, where the superalloy component has a protective ceramic coating.

16. The method of claims 4, 5, 6 or 7, where the superalloy component has a protective metallic and ceramic coating.

17. The method of claims 8, 9, 10, 11 or 12, where the superalloy component has a protective metallic coating.

18. The method of claims 8, 9, 10, 11 or 12, where the superalloy component has a protective ceramic coating.

19. The method of claims 8, 9, 10, 11 or 12, where the superalloy component has a protective metallic and ceramic coating.

20. The method of claim 1 where the damage state constitutes fatigue damage.

21. The method of claim 1 where the damage state constitutes creep damage.

22. The method of claim 1 where the damage state constitutes thermally induced damage.

23. The method of claim 1 where the damage state constitutes the development and/or propagation of microcracks.

24. The method of claim 1 where the damage state constitutes internal void formation.

25. The method of claim 1 where the damage state constitutes internal porosity growth and/or linkage.

26. The method of claim 1 where the damage state constitutes disbonding of interfaces.

27. The method of claim 1 where the damage state constitutes changes in grain size.

28. The method of claim 1 where the damage state constitutes changes in grain boundary morphology.

29. The method of claim 1 where the damage state constitutes changes in dislocation density.

30. The method of claim 1 where the damage state constitutes carbide degeneration.

31. The method of claim 1 wherein the superalloy turbine component has a protective coating and the damage state constitutes interactions between the base metal and the coating.

32. The method of claim 1 where the damage state constitutes phase precipitation and/or coarsening.

33. A method of determining the damage state, expended life and/or remaining life of a component of a steam turbine, heat exchanger, or generator using positron annihilation spectroscopy comprising:
providing a source of positrons which can interact with the atomic structure of said component;
acquiring gamma radiation data indicative of the size, type or quantity of defects present in said component; and
analyzing said data to determine the damage state, expended life or remaining life of said component.

34. The method of claim 33, wherein said positrons are provided internally in said component by injection of high energy particles into said component.

35. The method of claim 33, wherein said positrons are provided from a source external to said components.

36. A method of determining the damage state, expended life and/or remaining life of a metal, ceramic, plastic or composite article using positron annihilation spectroscopy comprising:
providing a source of positrons which can interact with the atomic structure of said article;
acquiring gamma radiation data indicative of the size, type or quantity of defects present in said article; and
analyzing said data to determine the damage state, expended life or remaining life of said article.

37. The method of claim 36, wherein said positrons are provided internally in said article by injection of high energy particles into said article.

38. The method of claim 36, wherein said positrons are provided from a source external to said article.

39. The method of claims 1, 33 or 36, wherein said data is acquired by a single gamma radiation detector.

40. The method of claims 1, 33 or 36, wherein said data is acquired by a plurality of gamma radiation detectors.

41. The method of claim 1, further comprising recording the coordinates of said gamma radiation.

42. The method of claim 41, further comprising combining said coordinates with information on said damage state, to produce a map of said damage on said turbine component or within said turbine.

43. The method of claim 33, further comprising recording the coordinates of said gamma radiation.

44. The method of claim 43, further comprising combining said coordinates with information on said damage state, to produce a map of said damage on said steam turbine, heat exchanger, or generator component or within said steam turbine, heat exchanger, or generator.

45. The method of claim 36, further comprising recording the coordinates of said gamma radiation.

46. The method of claim 45, further comprising combining said coordinates with information on said damage state, to produce a map of said damage on said article.

47. The method of 42, wherein said map results in a spatial pattern of damage, and said spatial pattern is analyzed to determine the damage state, expended life and remaining life of said component.

48. The method of 44, wherein said map results in a spatial pattern of damage, and said spatial pattern is analyzed to determine the damage state, expended life and remaining life of said component.

49. The method of 46, wherein said map results in a spatial pattern of damage, and said spatial pattern is analyzed to determine the damage state, expended life and remaining life of said article.
